(19) United States
(12) Patent Application Publication
(10) Pub. No.: US 2022/0235743 A1
(43) Pub. Date: Jul. 28, 2022

(54) IMPROVEMENTS FOR SERVICING A WIND TURBINE

(71) Applicant: Vestas Wind Systems A/S, Aarhus (DK)

(72) Inventors: Torben Ladegaard Baun, Skødstrup (DK); Per Holten-Møller, Silkeborg (DK); Jonas Lerche Schomacker, Solrød Strand (DK); Brian Jørgensen, Galten (DK)

(21) Appl. No.: 17/612,048

(22) PCT Filed: May 18, 2020
(86) PCT No.: PCT/DK2020/050142

§ 371 Date: Nov. 17, 2021

(30) Foreign Application Priority Data
May 21, 2019 (DK) PA 2019 70321

(51) Int. Cl. F03D 80/50; F03D 13/20

(52) U.S. Cl. CPC F03D 80/50; F03D 13/40; F03D 13/20

(57) ABSTRACT

The invention provides a method and a wind turbine (3) comprising a crane (401), wherein the wind turbine (3) further comprises an on-site control module (411), which is connectable to a remote control unit (421) located outside of the wind turbine (3), for receiving control data from the remote control unit (421), the control module (411) further being arranged to control the crane (401) in dependence on the control data.

### TECHNICAL FIELD

The present invention relates to improved service arrangements at a wind turbine. More particularly, the present invention variously relates to a wind turbine, a combination of a wind turbine and a remote control unit, a method for controlling a crane of a wind turbine, a computer program, or a computer readable medium.

### BACKGROUND INFORMATION

The invention provides improvements for servicing wind turbines, e.g. horizontal axis wind turbines. A horizontal axis wind turbine is known to have an electric generator in a nacelle on top of a tower, where a rotor with a substantially horizontal axis is mounted to the nacelle and arranged to drive the generator. The nacelle is usually arranged to be rotated in relation to the tower, to point the rotor towards the wind.

Servicing forms a significant part of the wind turbine lifetime costs, and as such, service costs also impact the cost of energy from wind turbines, or wind farms. Therefore, there is a desire to improve service arrangements at preferably to decrease service costs.

For many service operations, a crane, e.g. in the form of a hoist, may be disposed within a nacelle of a wind turbine, e.g. as described in EP2835335. The crane may be used to transport service equipment from a bottom of a tower of the wind turbine, to the nacelle. Such a crane or hoist may also be in the form of a winch.

### SUMMARY OF THE INVENTION

It is an object of the present invention is to facilitate servicing of wind turbines.

Thus, the invention provides a method at a wind turbine comprising a crane, wherein the wind turbine further comprises an on-site control module, which is connectable to a remote control unit located separately from the wind turbine, for receiving control data from the remote control unit, the on-site control module further being arranged to control the crane in dependence on the control data. In particular, the invention may relate to a wind turbine including a tower, a nacelle and a rotor with a hub, the wind turbine further comprising a crane with a hoisting element for engaging an object to be lifted with the crane. The wind turbine further includes an on-site control module associated with the crane, wherein the control module is connectable to a remote control unit which is separate from the wind turbine, wherein the control module is configured for receiving control data from the remote control unit, the control module further being arranged to control the crane in dependence on the control data from the remote control unit.

The control data may optionally be received from the remote control unit via a data transfer network, or by a direct radio link. The received control data may represent, or trigger, control instructions for the crane. Thus, in some embodiments, the received control data may include an instruction for controlling the crane. Thereby, the on-site control module may be arranged to control the crane according to the control data. In other embodiments, the received control data may include an instruction, not directly aimed at the crane control. However, the on-site control module may be adapted, e.g. programmed, such that the received control data triggers a crane control action. For example, the received control data may represent an instruction to prepare the wind turbine for a service action, and this preparation may involve activating the crane.

The on-site control module may be arranged to control the crane in any suitable manner. For example, the on-site control module may be arranged to control the crane via a cable, or wirelessly.

The crane may preferably be located in a component of the wind turbine. This wind turbine component may in particular be a nacelle for the wind turbine. The crane comprises a hoisting element, e.g. a wire or rope or chain, or a combination of these for raising or lowering or otherwise handling an object with the crane. Preferably, the on-site control module may be arranged to receive, in the control data, a service instruction, and to control, upon receiving the service instruction, the crane to lower the hoisting element outside of the wind turbine component. In particular, lowering the hoisting element may include lowering a free end thereof. A free end of the hoisting element may also be known as an attachment end. An attachment device for lifting, e.g. a hook or sling or yoke or other suitable attachment device may typically be fixed to or associated with a free end of the crane's hoisting element for connecting to a load for handling it by crane. The crane may further be provided with a drive device, for reeling the hoisting element in and out.

The remote control unit may be arranged to be connected to data transfer network, to send, via the data transfer network, the control data to the on-site control module, for the crane to lower the hoisting element device. The data transfer network may be a cellular network, or a mobile network. However, in some embodiments, the remote control unit may be arranged to send the control data to the on-site control module, via a direct radio link. The remote control unit may be arranged to be outside of the wind turbine component. Although in some embodiments, the remote control unit may be adapted to be carried, e.g. into the wind turbine.

As exemplified below, the crane may be mounted inside a wind turbine component such as a nacelle or a hub or a tower portion. In known service operations on wind turbines, a hatch, covering an opening in the wind turbine component, e.g. on the lower side of a nacelle or on the side of a tower or on the periphery of a hub, is opened. The free end of the hoisting element or the attachment device, e.g. the hook, of a crane may be lowered or hoisted down through the opening and outside of the wind turbine tower, and down to the tower bottom. Then, service equipment needed for the service operation is hoisted up into the wind turbine component. A typical hoisting speed of such a crane may be about 5 metres per minute. With such a speed, moving e.g. a hook down, and up again, will take 40 minutes where the wind turbine tower is 100 metres tall and where the crane is mounted in a component at or near the tower top.

The invention allows time-savings for service operations because one or more service technicians, e.g. a team of service technicians, can initiate the process of lowering the hoisting element before he/she/they arrive at the wind turbine. More specifically, by means of the remote control unit, a service technician can send control data to the on-site control module, for the on-site control module to control the crane, so as to lower a free end of the hoisting element, or e.g. a hook thereof, so that the hoisting element reaches to the tower bottom when the service technician arrives at the wind turbine. Thereby, the service technician, or a team of service technicians, saves time at the wind turbine. This time saving may provide a significant cost saving for, and/or productivity increase of the service team. Further, when leaving the wind turbine, a service technician can by means of the remote control unit, send control data to the on-site control module, for the on-site control module to control the crane to raise the hoisting element thereof, so that the hoisting element, in particular a free end thereof, preferably including an attachment device associated therewith is raised as the service technician, or the team of service technicians, is transported away from the wind turbine.

The invention is applicable to both onshore and offshore wind turbines. Since marine vessel operation costs may be relatively high, there may be a particularly high cost saving in offshore servicing using the invention. In addition, no substantial additional turbine equipment is required for the invention. Hence, embodiments of the invention are cheap to develop, and cheap to invest in. The invention may be introduced for new wind turbines as well as for installed wind turbines.

The invention is not only applicable to the wind turbine crane being comprised within a wind turbine component being a nacelle, being mounted on a tower, and housing a generator arranged to be driven by a rotor. The wind turbine component in which said crane is installed may alternatively be a rotor hub. The hub may present an opening with a hatch, through which a hoisting element, of a crane in the hub, may be lowered, or raised. The wind turbine component housing said crane may also be a wind turbine tower. Thereby, the hoisting element of the crane may be lowered and raised inside the tower. In further embodiments, the component housing said crane could be an arm of a multirotor wind turbine. Thereby, the crane could be located inside the arm, or outside of the arm. For example, the crane could be located on top of the arm. Similarly, where the wind turbine component housing said crane is a nacelle, the crane could be located externally of a shell of the nacelle, for example on a roof of the nacelle.

The on-site control module may be arranged to control the crane so as to stop lowering the hoisting element when a free end of the hoisting element is at the bottom of a tower on which the wind turbine component is mounted. The control module may be arranged to control a drive device of the crane. The control module may be arranged, e.g. programmed, based on the tower height, to stop lowering the hoisting element when the hoisting element reaches to the bottom of the tower, or when an attachment device at said free end of said hoisting element is at the bottom of the tower.

When the hoisting element reaches the bottom of the tower, it or a free end thereof may be in the vicinity of the bottom of the tower. The tower may be mounted on a foundation. The foundation may be an onshore foundation. When the hoisting element reaches the bottom of the tower, it or a free end thereof it may be or may be said to be at a ground level. When the hoisting element reaches to the bottom of the tower, the hoisting element may in particular be ready to use, e.g. from a vehicle, such as a service truck. When the hoisting element reaches the bottom of the tower, a free end thereof may optionally be kept at a distance above ground level, e.g. 2-8 metres, for example 2-6 metres or 2-4 metres. Keeping the free end of the hoisting element at such a distance above the ground may increase the safety for staff on the ground.

The foundation may be an offshore foundation. There could be a transition piece between the tower and the foundation. In optional embodiments, when the hoisting element reaches to the bottom of the tower, it may be ready to use from a vessel at an offshore wind turbine, or from a platform at the bottom of the tower.

The on-site control module may be arranged to receive, in the control data, a raising instruction, and to control, upon receiving the raising instruction, the crane so as to raise the hoisting element. The hoisting element may be raised outside of the wind turbine component in which the crane is comprised. Thus, the raising instruction may be provided for raising the hoisting element. In some embodiments, the raising instruction may represent an instruction to raise the hoisting element. In other embodiments, the on-site control module may be arranged, e.g. programmed, to raise the hoisting element upon receiving the raising instruction, without the instruction to raise being explicitly included in the raising instruction.

This could be the case, for example, where the raising instruction is an instruction to start the turbine. Such an instruction could be sent after a service process.

As suggested, the wind turbine nacelle may comprise an enclosing shell. The crane may be mounted inside the nacelle shell. Thereby, the invention may be adapted to configurations where the nacelle houses the crane. Thereby, the crane may be adapted to reach outside of the nacelle. In some alternative embodiments, the crane could be located outside of the shell of a nacelle.

The on-site control module may be arranged to control the crane so as to stop raising the hoisting element when it is fully inside the wind turbine, i.e. inside the wind turbine component in which the crane is located. For this, a sensor may be provided to sense when hoisting element is fully raised, or, in particular, to sense when a free end of a hoisting element is fully raised.

The wind turbine may present an opening. In the case of a crane being in a wind turbine component comprising an outer shell such as e.g. a nacelle or a hub, then the opening may be in a shell of said component. The wind turbine may further present a hatch arranged to cover the opening. The wind turbine may present an actuator arranged to control the hatch to open or close. Thereby, in optional embodiments, the crane may be arranged to position a free end of the hoisting element above the opening, or in particular, to position an attachment element associated with a free end of the hoisting element, above the opening. In some embodiments, the crane may be static in the wind turbine, or inside a component thereof. In other embodiments the crane may be movable inside a given component or mounted movable above said component. The crane may be, for example, a traverse crane or a winch on a gantry. Thereby, the reception of the control data, by the on-site control device, may trigger a sequence involving moving the crane or winch to a position above the hatch.

It should be noted that the invention is not applicable only to cranes adapted to lower the hoisting element through an opening beneath the crane. The crane may be a boom crane or jib crane. Thereby, the crane may be adapted to reach out through e.g. a nacelle roof opening, and over the side of the nacelle, to lower the hoisting element from there. Alternatively, a boom crane may be arranged to reach out through an opening in a side of a nacelle. In other arrangements, a crane may reach out through a hub opening or through a tower opening or over the side of a platform such as a helihoist or helicopter platform. In alternative embodiments, the crane may be a winch or hoist. In particular, a winch or hoist may be preferred in arrangements in which the hoisting element is to be lowered through a hatch, located below the crane/winch/hoist.

Preferably, the on-site control module is arranged to receive, in the control data, a service instruction, and to control, upon receiving the service instruction, the actuator so as to open a hatch. Preferably, the on-site control module is further arranged to control, upon receiving the service instruction, the crane to move the hoisting element through the opening. Thereby, the service instruction may be provided for lowering the hoisting element outside of the wind turbine component.

Preferably, the wind turbine comprises a sensor arranged to detect whether the relevant hatch is open. Thereby, the on-site control module may be arranged to receive signals from the sensor. The sensor may be of any suitable type. For example, the sensor may be a camera. Image processing software may be provided to determine, based on images from the camera, whether the hatch is open. Alternatively, the remote control unit may be arranged to receive images from the camera, and display them on a screen. Thereby, a person viewing the screen may be able to determine whether the hatch is open.

Preferably, the on-site control module is arranged to receive, in the control data, a raising instruction, and to control, upon receiving the raising instruction, the crane so as to raise the hoisting element. Preferably, the on-site control module is arranged to control, upon a free end of the hoisting element entering the wind turbine, or a relevant component thereof, the actuator so as to close the hatch. Thereby, the on-site control module may be arranged to send, upon the hatch closing, to the remote control unit, confirmation data representing information that the hatch is closed.

Preferably, the wind turbine is arranged to lower, and raise, the hoisting element outside of the wind turbine tower. The object is also reached with a wind turbine comprising a crane, wherein the wind turbine further comprises an on-site control module, which is connectable to a remote control unit located separately from the wind turbine, for receiving control data from the remote control unit, the on-site control module further being arranged to control the crane in dependence on the control data. Embodiments of the wind turbine may present features of the wind turbine component, described elsewhere in this document. The on-site control module, and the crane, may preferably be comprised in a same component of a wind turbine. However, in some embodiments, the on-site control module, and the crane, may each form a part of a respective separate component of the wind turbine. Thereby, control signals from the on-site control module to the crane may be transferred from one component to another component of the wind turbine.

The object is also reached with a combination of a wind turbine as described above, or a wind turbine component as described above, and a separate remote control unit, the remote control unit being arranged to be connected to a data transfer network, and to send the control data to the on-site control module via the network. The control module, and the remote control unit may form a control system, for controlling the crane. The on-site control module, and the remote control unit may provide a group of computers, for controlling the crane. The remote control unit may be arranged for wireless control data transfer. The remote control unit may be a mobile communication device, e.g. a smart phone. Thereby, the adaption of the mobile device, to embodiments of the invention, may be provided by a computer program, e.g. an application, installed on the mobile communication device. For example, the program may be adapted to send the service instruction mentioned above. As a further example, and as suggested, where the wind turbine is provided with a sensor in the form of a camera, for determining whether the hatch is open, or closed, the program could be adapted to present one or more images from the camera on the mobile communication device. In some embodiments, the remote control device could be stationary, for example in the form of a stationary computer. Preferably, the remote control unit is portable, such as a pocket device or laptop or electronic notepad type device.

The object is also reached with an on-site control module for a wind turbine as described above, or for a combination of a wind turbine, and a remote control unit, as described above. Preferably, the on-site control module is connectable to a remote control unit located outside of the wind turbine, or outside a relevant wind turbine component, for receiving control data.

The on-site control module may further be arranged to control the crane in dependence on the control data. The on-site control module may be connectable to the remote control unit via a data transfer network, for receiving control data representing, or triggering, control instructions for the crane. Preferably, the control module is arranged to receive, in the control data, a service instruction, and to control, upon receiving the service instruction, the crane so as to lower the hoisting element. Preferably, the on-site crane control module is arranged to control the crane so as to stop lowering the hoisting element when a free end of the hoisting element is at the bottom of a tower on which the wind turbine component is mounted. Preferably, this on-site control module is arranged to receive, in the control data, a raising instruction, and to control, upon receiving the raising instruction, the crane so as to raise the hoisting element outside of the wind turbine component. Preferably, the control module is arranged to control the crane so as to stop raising the hoisting element when the hoisting element is inside the wind turbine or inside or within the relevant component thereof. Preferably, the on-site control module is arranged to receive, in the control data, a service instruction for lowering the hoisting element, to control, upon receiving the service instruction, the actuator so as to open a hatch arranged to cover an opening in a wind turbine component shell, and to control the crane so as to move the hoisting element through the opening.

The object is also reached with a method for controlling a crane of a wind turbine, the wind turbine including a tower, a nacelle and a rotor with a hub, the crane comprising a hoisting element for engaging an object to be lifted with the crane. The wind turbine further comprising an on-site control module associated with the crane; said method being characterised by sending, by means of a remote control unit located separately from the control module, a service instruction to said control module, and upon the control module receiving said service instruction, operating the crane, by means of the control module, to thereby raise or lower the hoisting element. In particular, raising or lowering the hoisting element may comprise raising or lowering the hoisting element outside of said wind turbine.

The crane may be located in a component of the wind turbine, preferably in a principal component thereof. The wind turbine component may be mounted on a tower. A principal component of a wind turbine may in particular include a nacelle or a rotor hub or a tower segment or a platform on a nacelle.

The service instruction may be sent via a data transfer network. Thus, embodiments of the invention may comprise controlling, when located outside of the wind turbine, by means of a remote control unit connected to a data transfer network, and an on-site control module, connected to the data transfer network, the crane, by means of the on-site control module, so as to lower the hoisting element. The method may comprise requesting, by means of the remote control unit, the connection with the on-site control module, via the data transfer network.

The remote control unit may be located separately from the wind turbine. The remote control unit may be located remotely from the wind turbine during the step of sending the service instruction. The term “remotely” in this context may designate a location outside a wind turbine in which the crane and its control module are located. In embodiments, the term “remote” may designate a distance away from the relevant wind turbine, for example, a distance corresponding to a time period for reaching the wind turbine of five minutes or more, such as e.g. ten minutes or fifteen or twenty minutes or more. A distance away from a relevant wind turbine may include a distance by foot or by powered vehicle such as a service truck. The remote control unit may be on land, or in a marine vessel. The remote control unit may be used to trigger the lowering of the hoisting element before arriving at the relevant wind turbine. Said usage may occur while underway e.g. on foot, on a bicycle or in a powered vehicle.

Preferably, where the wind turbine comprises a tower, and a component mounted on the tower, which component comprises the crane, lowering the hoisting element may comprise lowering the hoisting element outside of the wind turbine component, and outside of the tower. Thereby, the method may comprise, before lowering the hoisting element, determining a wind direction at the wind turbine, and rotating the wind turbine component around a yaw axis of the wind turbine so as for the hoisting element to be lowered on a leeward side of the tower. Thereby, the hoisting element may be lowered, and later raised, where it is relatively undisturbed by the wind. The control module may be arranged, e.g. programmed, to yaw the turbine, upon receiving the service instruction. Alternatively, control data representing an instruction to yaw the turbine may be sent by the remote control unit, before the step of sending the service instruction. It is understood that the yaw axis may be a vertical axis, around which the wind turbine nacelle or hub is arranged to rotate.

In some embodiments, where the wind turbine comprises a tower and a component mounted on the tower, which component includes the crane, the method may comprise, before lowering the hoisting element, rotating the wind turbine component around a yaw axis of the wind turbine so as to lower the hoisting element on a side of the tower, which is accessible by a vehicle. This is advantageous, where there is a side of the wind turbine which is not accessible by a vehicle, e.g. due to vegetation, or an uneven terrain.

Preferably, where the wind turbine comprises a tower, and a component mounted on the tower, which component includes the crane, the method comprises controlling, by means of the control module, the crane so as to stop lowering the hoisting element when a free end of the hoisting element is at the bottom of the tower. Thereby, the hoisting element may be readily accessible for a service technician team arriving at the wind turbine.

Where the crane is provided in a component of the wind turbine, the method preferably comprises controlling, by means of the control module, upon receiving the service instruction, an actuator so as to open a hatch arranged to cover an opening in a shell of a wind turbine nacelle or hub, wherein lowering the hoisting element comprises moving the hoisting element through the opening.

Preferably, the method comprises sending, by means of the remote control unit, located outside of the wind turbine, a raising instruction to the control module, and controlling, upon receiving the raising instruction, by means of the control module, the crane so as to raise the hoisting element. The hoisting element may be raised outside of the wind turbine or wind turbine component. Preferably, the method comprises determining whether a free end of the hoisting element has, as a result of the raising of the hoisting element, entered the wind turbine component through the opening. Preferably, the method comprises controlling, upon determining that a free end of the hoisting element has entered to wind turbine, the actuator, by means of the control module, to close the hatch. Preferably, the method comprises sending, upon closing the hatch, by means of the control module, to the remote control unit, close confirmation data representing information that the hatch is closed.

In some embodiments, the method comprises identifying a condition indicative of a person being present in the wind turbine, or of a possibility of a person being present in the wind turbine or in a relevant component thereof which includes a crane, and, upon identifying the condition, disregarding the service instruction. The condition may be identified by the on-site control module. The identified condition may be for example that the wind turbine is in a service mode. In a service mode the turbine may be shut down. Further, in a service mode, there may be one or more persons in the turbine. Thus, preferably, when said condition is present, there is no operation of the crane, in response to the service instruction, to lower the hoisting element. In some embodiments, when said condition is present, there is no operation, in response to the service instruction, of the actuator to open the hatch, as described above.

A method according to the invention is defined in appended claim 1. Optional features thereof are defined in subclaims 2-12. A computer program or computer program product—such as a computer readable medium carrying a computer program—relating to the method of the invention is defined in appended claim 13. A wind turbine according to the invention is defined in appended claim 14. Optional features thereof are defined in appended claims 15-18. A system according to the invention is defined in appended claim 19.

### BRIEF DESCRIPTION OF THE DRAWINGS

Below, embodiments of the invention will be described with reference to the drawings, in which

FIG. 1 shows a perspective view of a wind turbine, a schematic depiction of a data transfer network, and a plan view of a mobile communications device,

FIG. 2 shows a cross-sectional schematic view of a nacelle of the wind turbine in FIG. 1, the section being vertical and parallel with a rotor axis of the wind turbine, and

FIG. 3a, FIG. 3b, and FIG. 3c depict steps in a method according to an embodiment of the invention.

### DETAILED DESCRIPTION OF EMBODIMENTS

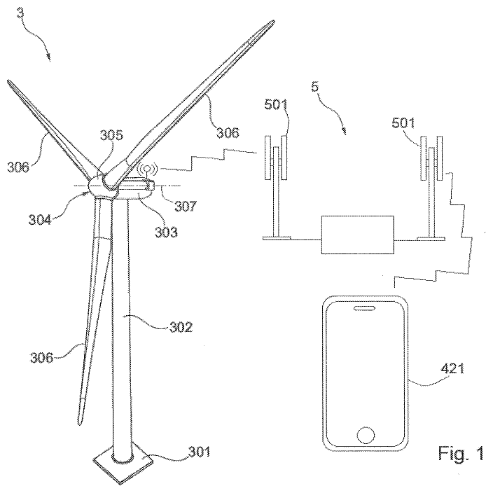

Reference is made to FIG. 1. A wind turbine 3 includes a foundation 301, and a tower 302 coupled to the foundation 301 at a lower end thereof. A wind turbine component, shown in the form of a nacelle 303, is disposed at the apex of the tower 302. A rotor 304 may be operatively coupled to a generator housed inside the nacelle 303. The rotor 304 of the wind turbine 3 may serve as the prime mover for an electromechanical system of the wind turbine. In addition to the generator, the nacelle 303 may house miscellaneous components required for converting wind energy into electrical energy. The nacelle 303 may also house various components needed to operate, control, and optimize the performance of the wind turbine 3. While an on-shore wind turbine 3 is illustrated in FIG. 1, it should be recognised that embodiments of the present invention may also be used for off-shore wind turbines.

The rotor 304 of wind turbine 3 may include a wind turbine component, in the form of a central hub 305. One or more blades 306 may project outwardly from the central hub 305. In the representative embodiment, the rotor 304 includes three blades 306, but the number may vary. The wind turbine may be a horizontal-axis wind turbine. The blades 306 may be configured to interact with the passing air flow to produce lift that causes the rotor 304 to rotate about a substantially horizontal axis 307.

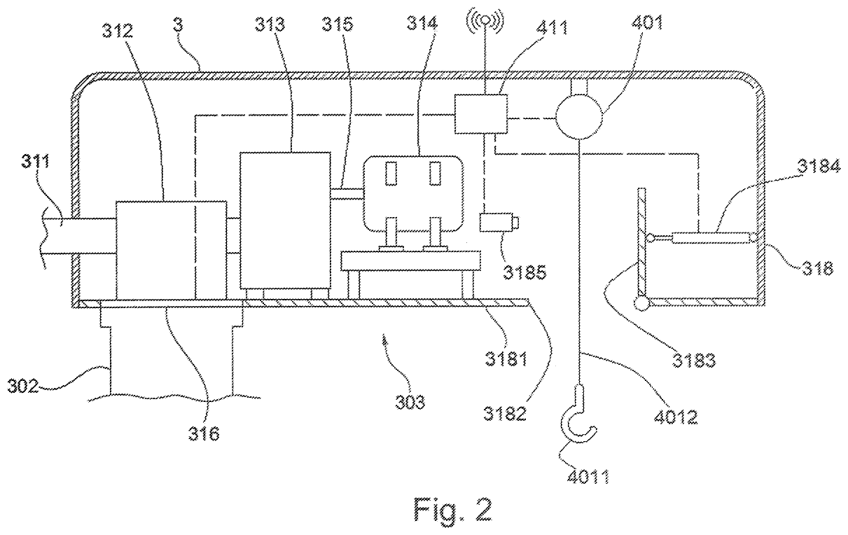

FIG. 2 shows a cross-section of the nacelle 303. A rotor shaft 311 may be supported by two or more bearings in a shaft housing 312, herein also referred to as a main bearing housing. The rotor shaft 311 may be arranged to connect the rotor 304 to a gearbox 313. The generator 314 may be connected to the gearbox 313 via a high-speed shaft 315.

The nacelle 303 may be connected to the tower 302 via a yaw system 316. The yaw system 316 may include a yaw bearing, and one or more yaw motors, (not depicted in detail). The shaft housing 312 may be mounted on top of the yaw bearing 316.

The nacelle 303 may comprise a shell 318. The shell 318 may enclose the components in the nacelle. The shell 318 may comprise a lower nacelle structure 3181. The lower nacelle structure may be fixed to the shaft housing 312. The lower nacelle structure 3181 may provide, or support, a floor inside the nacelle 303. The lower nacelle structure 3181 may support the gearbox 313. The generator 314 may be supported by the lower nacelle structure 3181.

The wind turbine 3 may present an opening 3182. The opening may for example be provided in the lower nacelle structure 3181, as exemplified in FIG. 2. The opening 3182 may alternatively be located on a side of the tower 302 which is opposite to the side of the rotor 304, (FIG. 1). The wind turbine 3 may comprise a hatch 3183, arranged to cover the opening 3182.

The wind turbine 3 may comprise further openings, (not shown). For example, there could be an opening on a top side of the nacelle 303. Further, there could be one or more openings in side panels of the nacelle shell 318. There could be openings in a shell of the hub 305 or in a segment of the tower 302 or at other locations at a wind turbine 3. For each opening 3182, one or more hatches 3183 may be provided to cover the respective opening 3182.

A crane 401 may be mounted inside the wind turbine 3, more particularly, inside a principal component thereof. The crane 401 may comprise a hoisting element 4012 for engaging an object to be lifted with the crane 401. In the illustrated embodiment, a free end of the hoisting element 4012 is shown provided with an attachment device 4011 in the form of e.g. a hook. An attachment device 4011 may be any suitable attachment device for connecting to and raising, lowering or otherwise handling a load by crane or winch. The attachment device 4011 may be connected to a hoisting element 4012 which may be in the form of an elongated flexible lifting line, e.g. a wire, a chain or a fibre rope. The hoisting element 4012 may be arranged to be wound up on a drum (not shown) in a housing of the crane 401.

The crane 401 may be mounted above the opening 3182. Thereby, the crane 401 may be arranged to position a free end of the hoisting element 4012 above the opening. The crane 401 may for example be mounted in a ceiling of a nacelle 303, or a structure close to the ceiling. The crane 401, or winch, may be static in the nacelle 303. In some embodiments, the crane 401 may be movable in the nacelle 303. For example, the crane 401 may be arranged to move, by means of a guide arrangement, along the rotor axis 307 (FIG. 1), and/or transversally thereto.

The wind turbine 3 may further comprise a control module 411 also referred to as an on-site control module. The control module 411 may be connectable to a data transfer network 5, as exemplified in FIG. 1. For this the control module 411 may comprise a radio transceiver arranged to communicate with a communications station 501 of the network.

The control module 411 may be configured to control the crane 401, for example as indicated in FIG. 2. The control module 411 may be arranged to control the crane 401 by means of a control connection between the control module 411, and the crane 401. The control module 411 may be arranged to control the crane 401 in dependence on control data. The control data may be received via the data transfer network 5. Said control data may represent, or trigger, control instructions for the crane 401.

The wind turbine 3 may comprise an actuator 3184, arranged to control a hatch 3183 so as to open or close. The actuator 3184 may be, for example, a hydraulic actuator, or an electric actuator.

The wind turbine 3, or a principal component thereof in which said crane 401 is included, may further comprise a sensor 3185, arranged to detect whether the hatch 3183 is open. The sensor 3185 may be, for example, a camera or another device for automatically or manually sensing the presence of an operator in a relevant component housing a crane 401.

The control module 411 may be arranged to control the hatch 3183 by means of the actuator 3184, for example as indicated in FIG. 2. The control module 411 may be arranged to control a hatch 3183 in dependence on the control data, that may be received via the data transfer network 5. Said control data may represent, or trigger, control instructions for the hatch 3183. When open, a hatch 3183 may allow the hoisting element 4012—or an attachment device 4011 thereof—to be passed through an opening 3182.

In some embodiments, e.g. in a nacelle 303 where there is a floor structure (not shown) in a nacelle 303, above a lower nacelle structure 3181, the floor structure could present an opening with a hatch, above the lower nacelle structure opening 3182. The floor hatch may also be arranged to be controlled by the control module 411, by means of an actuator. Thus, there may be two openings for the hoisting element to pass through, one above the other.

The control module 411 may be arranged to control a yaw system 316, for example as indicated in FIG. 2. The control module 411 may be arranged to control the yaw system 316 in dependence on the control data, that may be received via the data transfer network 5. Said control data may represent, or trigger, control instructions for the yaw system 316.

A remote control unit 421 may be arranged to be connected to the data transfer network 5. The remote control unit 421 may be arranged to send the control data to the control module via the network 5. The remote control unit 421 may be adapted to be hand-held by a wind turbine service technician. The remote control unit 421 may be a mobile communication device, e.g. a smart phone.

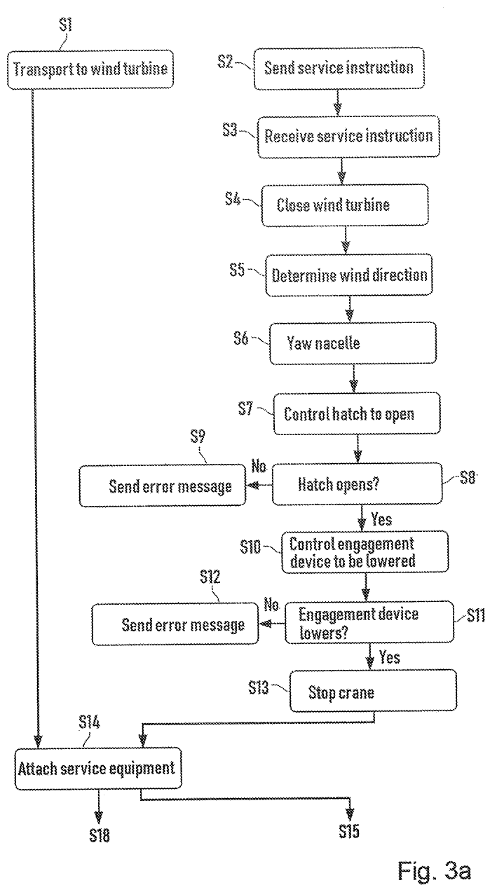

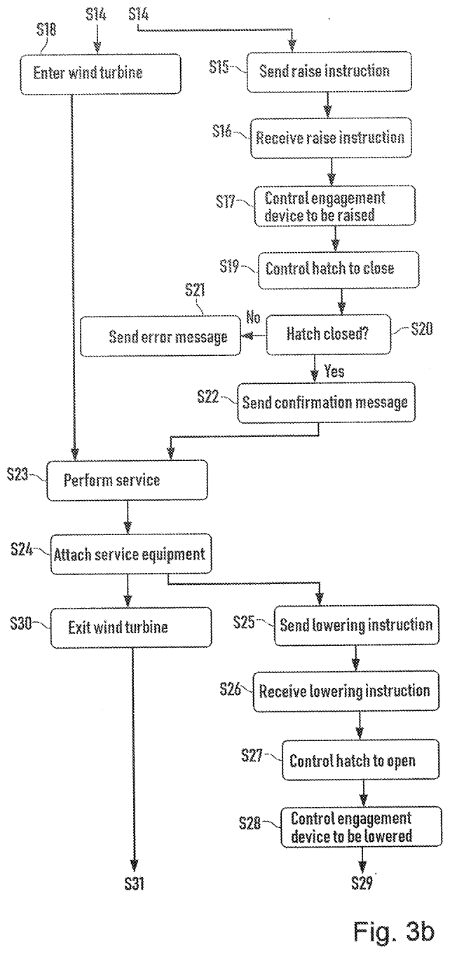

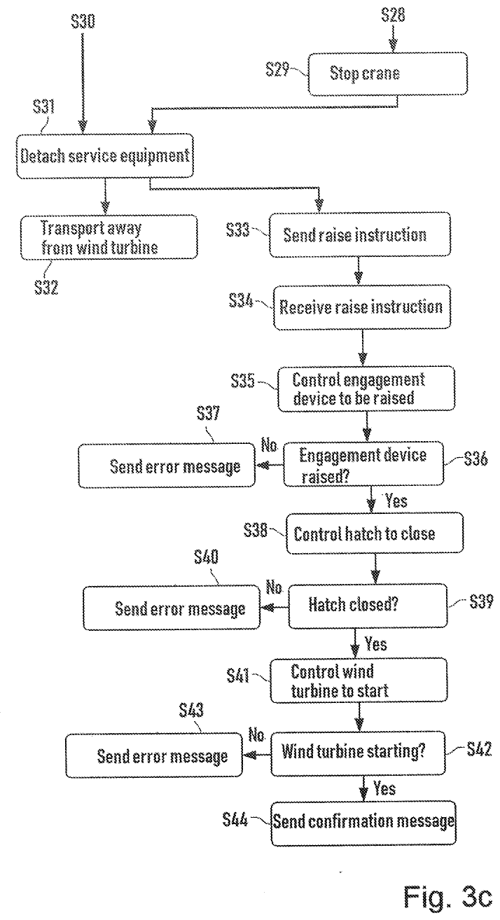

FIG. 3a-FIG. 3c depict steps in a method relating to exemplary aspects of a service method and wind turbine and system described herein.

The method may comprise transporting 51 one or more wind turbine service technicians, and service equipment, to the wind turbine in FIG. 1. The service equipment may comprise one or more spare parts, exchange elements or subsystems, exchange liquids (e.g. oil, cooling liquid, etc), and/or tools. The service equipment may also comprise other items, such as a fire extinguisher, and/or life saving equipment. The means for transport may be one or more vehicles, (not shown). Alternatively, the means for transport may be one or more marine vessels, (not shown), e.g. where the wind turbine is an offshore wind turbine.

The method may further comprise sending S2 a service instruction to the control module 411, (FIG. 2). The service instruction may be sent by means of a remote control unit 421, (FIG. 1). When sending the service instruction, the remote control unit 421 may be located remotely from the wind turbine 3. The service instruction may be sent by one of the service technicians during the transport S1 to the wind turbine. The service instruction may be sent via the data transfer network 5.

The method may further comprise receiving S3, by means of the control module 411, (FIG. 2), the service instruction. Upon the control module receiving S3 the service instruction, the wind energy extracting operation of the wind turbine may be terminated S4, herein also referred to as the wind turbine being closed. The wind turbine may be closed by the control module 411 controlling blade pitch devices (not shown), and the generator 314, in a manner which is known per se.

Also, upon the control module 411 receiving S3 the service instruction, a wind direction at the wind turbine may be determined S5. The wind direction may be determined by the control module 411, by means of a wind instrument, (not shown), of the wind turbine 3. Upon determining the wind direction, the yaw system 316 may be controlled S6 so as to rotate a component of the wind turbine housing or supporting a crane 401. For example, the nacelle 303 may be rotated around a yaw axis of the wind turbine 3. Thereby, the relevant wind turbine component may be positioned so that an opening 3182 is on the leeward side of the tower 302. Thereby, the hoisting element 4012 may be lowered, as exemplified below, on the leeward side of the tower 302.

The method may further comprise controlling S7, by means of the control module, upon rotating the relevant component housing a crane 401, an actuator 3184 so as to open a hatch 3183. The method may comprise determining S8 whether the hatch 3183 opens, e.g. by means of a sensor 3185. If the hatch 3183 does not open, an error message may be sent S9 to the remote control unit 421, (FIG. 1).

The method may further comprise, if the hatch 3183 opens, controlling S10, by means of the control module, upon opening the hatch 3183, the crane 401 so as to lower the hoisting element 4012 or an attachment device 4011 associated therewith (these are referred to in S10 collectively as “engagement device”), through the opening 3182. The method may comprise determining S 11 whether the hoisting element 4012 or attachment device 4011 is lowered, e.g. by means of the control connection between the control module 411, and the crane 401. If the hoisting means 4012 or attachment device 4011 (referred to collectively in S11 as “engagement device”) is not lowered, an error message may be sent S12 to the remote control unit 421, (FIG. 1).

Once outside the nacelle 303, the hoisting element 4012 may be lowered along the tower 302. When the hoisting element 4012 reaches to the bottom of the tower 302, the crane 401 may be controlled S13 so as to be stopped. The crane 401 may be stopped by the control module 411 in dependence on a stop function, determined based on the height of the tower 302. When crane 401 has been stopped, a confirmation message may be sent to the remote control unit 421, (FIG. 1).

As suggested above, the method may comprise identifying a condition indicative of a person being present in the wind turbine, or of a possibility of a person being present in the wind turbine or in a relevant component thereof, and, upon identifying the condition, disregarding the service instruction. The condition may be identified by the control module 411. The identified condition may be for example that the wind turbine 3 is in a service mode. Thus, when the service instruction is sent S2, the wind turbine 3 may already be in a service mode.

Thereby, the safety of any person present in the wind turbine 3 when the service instruction is received S3, is not compromised. Upon the condition being identified, a message may be sent to the remote control unit 421, indicating that there is no operation of the crane 401, in response to the issued service instruction to lower the hoisting element 4012.

The method may comprise the service technician(s) arriving at the wind turbine, when the hoisting element 4012 has been lowered to reach the ground, and stopped at the bottom of the tower 302. Thereby, the service equipment may be attached S14 to the hoisting element 4102 or to an attachment device 4011 associated therewith.

Upon attaching S14 the service equipment, a raising instruction is sent S15 to the control module 411, by means of the remote control unit 421 (FIG. 1). Upon the control module 411 receiving S16 the raising instruction, the crane 401 may be controlled S17, by means of the control module 411, so as to raise the hoisting element 4102 or attachment device 4011 associated therewith (referred to collectively as “engagement device” in S17), with the attached service equipment.

Also, after attaching S14 the service equipment, one or more of the service technician(s) may enter S18 the wind turbine 3. The service technician(s) may e.g. enter the nacelle 303 via the tower 302.

When the hoisting element 4012 or an attachment device 4011 connected thereto has entered the wind turbine 3 3 through an opening 3182 (FIG. 2), the control module 411 may control S19 an actuator 3184 to close the hatch 3183 associated with said opening 3182. The method may comprise determining S20 whether the hatch 3183 closes, e.g. by means of a sensor 3185. If the hatch 3183 does not close, an error message may be sent S21 to the remote control unit 421, (FIG. 1). If the hatch 3183 closes, a confirmation message may be sent S22 to the remote control unit 421.

Upon receiving the hatch closing confirmation message, service operations may be performed S23 at the wind turbine 3. Upon service being completed, service equipment may be attached S24 to the hoisting element 4012. The service equipment may comprise one or more used spare parts, waste liquids, and/or service tools.

Upon attaching the service equipment, a lowering instruction may be sent S25 to the control module 411, (FIG. 2). The service instruction may be sent by means of the remote control unit 421, (FIG. 1). The method may further comprise receiving S26, by means of the control module 411, (FIG. 2), the lowering instruction. Upon the control module receiving the lowering instruction, an actuator 3184 may be controlled S27, by means of the control module, to open an opening 3182 by means of a relevant hatch 3183. The method may further comprise controlling S28, by means of the control module, upon opening the hatch 3183, the crane 401 so as to lower the hoisting element 4012 or an attachment device 4011 connected thereto (referred to collectively as “engagement device” in S28) through the opening 3182. When the hoisting element 4012 reaches to the bottom of the tower 302, the crane 401 may be controlled S29 to be stopped.

The method may also comprise the service technician(s) exiting S30 at the wind turbine. Thereupon, the service equipment may be detached S31 from the hoisting element 4012.

Upon detaching the service equipment, the service technician(s), and the service equipment, may be transported away from the wind turbine 3.

The method may further comprise sending S33 a raising instruction to the control module 411, (FIG. 2). The raising instruction may be sent by means of the remote control unit 421, (FIG. 1). When sending the raising instruction, the remote control unit 421 may be located remotely from—that is to say, away from—the wind turbine 3. The raising instruction may for example be sent by one of the service technicians during the transport S1 away from the wind turbine 3.

The method may further comprise receiving S34, by means of the control module 411, (FIG. 2), the raising instruction. Upon the control module receiving S3 the raising instruction, the crane 401 may be controlled S35 so as to raise the hoisting element 4012 or an attachment device 4011 connected thereto (referred to collectively as “engagement device” in S28). The method may comprise determining S36 whether the hoisting element 4012 or an attachment device connected thereto (referred to collectively as “engagement device” in S28) is raised, e.g. by means of the control connection between the control module 411, and the crane 401. If the hoisting element 4012 or an attachment device 4011 connected thereto is not raised, an error message may be sent S37 to the remote control unit 421, (FIG. 1).

When the hoisting element 4012 or an attachment device 4011 connected thereto is inside the wind turbine 3, the crane 401 may be controlled to be stopped. The method may further comprise controlling S38, by means of the control module 411, an actuator 3184 to close a corresponding hatch 3183. The method may comprise determining S39 whether the hatch 3183 is closed, e.g. by means of a sensor 3185. If the hatch 3183 is not closed, an error message and/or alert message or signal may be sent S40 to the remote control unit 421, (FIG. 1).

If the hatch 3183 is confirmed to be correctly closed, the wind turbine 3 may be controlled S41 to start. The method may comprise determining S42 whether the wind turbine 3 starts correctly. If the wind turbine does not start, an error message or corresponding alert may be sent S43 to the remote control unit 421, (FIG. 1). If the wind turbine 3 does start, confirmation message may be sent S44 to the remote control unit 421.

1. A method for controlling a crane in a wind turbine, said wind turbine including a tower, a nacelle and a rotor with a hub, the crane comprising a hoisting element for engaging an object to be lifted with the crane, said wind turbine further comprising an on-site control module associated with said crane; wherein said method further includes sending, by means of a remote control unit located separately from the control module, a service instruction to said control module, and upon the control module receiving said service instruction, operating the crane, by means of the control module, to raise or lower said hoisting element.

2. The method according to claim 1, wherein the remote control unit is located remotely from the wind turbine during the step of sending the service instruction.

3. The method according to claim 1, wherein the method further comprises, before raising or lowering the hoisting element, determining a wind direction at the wind turbine, and rotating a nacelle of said wind turbine around a yaw axis of the wind turbine so as to enable the hoisting element to be raised or lowered on a leeward side of the tower of said wind turbine.

4. The method according to claim 1, wherein the method further comprises, before lowering the hoisting element, rotating a nacelle of said wind turbine around a yaw axis of the wind turbine so as to lower the hoisting element on a side of the tower said wind turbine, which is accessible by a service vehicle.

5. The method according to claim 1, the method further comprising operating, by means of said on-site control module, the crane so as to stop lowering the hoisting element when the hoisting element reaches to the bottom of the tower of said wind turbine.

6. The method according to claim 1, the method further comprising controlling, by means of said control module, upon receiving said service instruction, an actuator so as to open a hatch arranged to cover an opening in said wind turbine, wherein lowering the hoisting element comprises moving the hoisting element through the opening.

7. The method according to claim 1, comprising sending, by means of the remote control unit located outside of the wind turbine, a raising instruction to said control module, and operating, upon receiving the raising instruction, by means of said control module, the crane so as to raise the hoisting element.

8. The method according to claim 7, comprising determining whether the hoisting element has, as a result of the raising of the hoisting element, fully entered through said opening of said wind turbine.

9. The method according to claim 8, comprising controlling, upon determining that an attachment device of the hoisting element has fully entered the wind turbine, an actuator, by means of the control module, to close said hatch.

10. The method according to claim 9, comprising, upon closing of the hatch, sending to the remote control unit, hatch closure confirmation data representing information that the hatch is closed.

11. The method according to claim 1 any previous claim, wherein said crane is located in a component of said wind turbine, said component preferably being either a nacelle or a rotor hub, or a tower segment, or at a platform at a nacelle of said wind turbine.

12. The method according to claim 11, comprising identifying a condition indicative of a person being present in said wind turbine component and, upon identifying the condition, said control module disregarding the service instruction from said remote control unit.

13. A computer program or computer program product comprising program code for performing the steps of claim 1 when said program is run on a computer, or a group of computers.

14. A wind turbine including a tower, a nacelle and a rotor with a hub, said wind turbine further comprising a crane with a hoisting element for engaging an object to be lifted with the crane, said wind turbine including an on-site control module associated with said crane, wherein said control module is connectable to a remote control unit separate from said wind turbine, wherein said control module is configured for receiving control data from the remote control unit, the control module further being arranged to control said crane in dependence on said control data.

15. The wind turbine according to claim 14, wherein said wind turbine presents an opening and wherein a hatch is arranged to cover the opening, and wherein an actuator associated with said control module is arranged to control the hatch to open or close.

16. The wind turbine according to claim 15, wherein the crane is arranged to position said hoisting element above the opening.

17. The wind turbine according to claim 15, said wind turbine further comprising a sensor arranged to detect whether the hatch is open, said sensor being associated with said control module.

18. (canceled)

19. A system including a wind turbine according to claim 14 and a remote control unit, the remote control unit being arranged to be connected to a data transfer network, and to send the control data to the on-site control module via the network, preferably wherein said remote control unit is a mobile communication device.
